(19) United States
(12) Patent Application Publication
(10) Pub. No.: US 2025/0233474 A1
(43) Pub. Date: Jul. 17, 2025

(54) MOTOR

(71) Applicant: MINEBEA MITSUMI Inc., Kitasaku-gun, Nagano (JP)

(72) Inventors: Yuya SENDA, Kitasaku-gun, Nagano (JP); Toshiyuki NISHIKATA, Kitasaku-gun, Nagano (JP); Tsuyoshi KANO, Kitasaku-gun, Nagano (JP)

(21) Appl. No.: 18/853,794

(22) PCT Filed: Apr. 14, 2022
(86) PCT No.: PCT/JP2022/017822

§ 371 Date: Oct. 3, 2024

(51) Int. Cl. H02K 5/10

(52) U.S. Cl. CPC H02K 5/10

(57) ABSTRACT

A motor includes a shaft including one end part and the other end part, a tube, a bearing rotatably supporting one of the shaft and the tube and fixed to the other of the shaft and the tube, a lid covering the bearing and the tube, and an urging structure. The lid includes a first wall fixed to the shaft and a second wall fixed to the tube, the first wall and the second wall oppose each other directly or via a washer in a longitudinal direction of the shaft, and the urging structure urges the first wall toward the second wall in the longitudinal direction of the shaft.

### TECHNICAL FIELD

The present invention relates to a motor.

### BACKGROUND ART

For example, a brushless motor having a configuration as described in Patent Document 1 below may be used.
Patent Document 1: JP 10-127001 A

### SUMMARY OF INVENTION

In recent years, there has been a demand for motors with such waterproof performance.

Therefore, an object of the present invention is to provide a motor with waterproof performance.

A motor according to the present invention includes a rod including one end part and the other end part, a tube, a bearing rotatably supporting one of the rod and the tube and fixed to the other, a lid covering the bearing and the tube, and an urging structure. The lid includes a first wall fixed to the rod and a second wall fixed to the tube. The first wall and the second wall oppose each other directly or via another member in a longitudinal direction of the rod, and the urging structure urges the first wall toward the second wall in the longitudinal direction of the rod.

In addition, the first wall may extend in a radial direction from the rod, and the second wall may extend, in the radial direction, in a direction from the tube toward the rod.

In addition, the urging structure may include a magnet, and the first wall may be urged toward the second wall by a magnetic force. In this case, one of the first wall and the second wall may include a magnetic body, and the other of the first wall and the second wall may include the magnet.

In addition, the motor may include the other member sandwiched between the first wall and the second wall.

In addition, the lid may include an annular member fixed to the rod and a tubular member fixed to the tube, the annular member may include the first wall, the first wall may include a magnet, the tubular member may include a sleeve fixed to the tube and the second wall extending from the sleeve toward the rod, and the second wall may include a magnetic body. In addition, in this case, a gap may be present between an outer peripheral part of the first wall and the sleeve in the radial direction, a gap may be present between an inner peripheral part of the second wall and an outer peripheral surface of the rod in the radial direction, and the first wall and the second wall may form a labyrinth.

In addition, the motor may include a rotor fixed to the rod and a stator, the urging structure may include a magnetic body of the rotor and a magnet provided to the stator, the lid may include an annular member fixed to the rod and a tubular member fixed to the tube, the annular member may include the first wall, the tubular member may include a sleeve fixed to the tube and the second wall extending from the sleeve toward the rod, and the first wall may be urged toward the second wall by a magnetic force acting on the magnetic body of the rotor and the magnet provided to the stator. In this case, a gap may be present between an outer peripheral part of the first wall and the sleeve in the radial direction, a gap may be present between an inner peripheral part of the second wall and an outer peripheral surface of the rod in the radial direction, and the first wall and the second wall may form a labyrinth.

In addition, the motor may include a housing including the tube, a rotor fixed to the rod, and a stator fixed to the housing directly or via another member, and the bearing may rotatably support the rod and may be fixed to the tube.

### BRIEF DESCRIPTION OF DRAWINGS

FIG. 1 is a perspective view of a motor according to a first embodiment of the present invention, as viewed from one side.

FIG. 2 is a perspective view of the motor illustrated in FIG. 1, as viewed from the other side.

FIG. 3 is a cross-sectional view of the motor illustrated in FIG. 1, taken along a direction of a shaft.

FIG. 4 is an enlarged view of a connector illustrated in FIG. 2.

FIG. 5 is a view of a lid illustrated in FIG. 1 in an exploded state, together with a housing.

FIG. 6 is an enlarged view of a part of the motor illustrated in FIG. 4.

FIG. 7 is a cross-sectional view of a motor according to a modification of the first embodiment of the present invention, taken along the direction of the shaft.

FIG. 8 is a cross-sectional view of a motor according to a second embodiment of the present invention, taken along the direction of the shaft.

FIG. 9 is a cross-sectional view of a motor according to a modification of the second embodiment of the present invention, taken along the direction of the shaft.

### DESCRIPTION OF EMBODIMENTS

Embodiments for implementing a motor according to the present invention will be described below together with the accompanying drawings. The embodiments described below are intended to facilitate the understanding of the present invention and are not intended to be construed as limiting the present invention. The present invention can be modified and improved from the following embodiments without departing from the gist of the present invention. In addition, in the accompanying drawings, for ease of understanding, dimensions of respective members may be exaggerated or reduced, or hatching may be omitted.

### First Embodiment

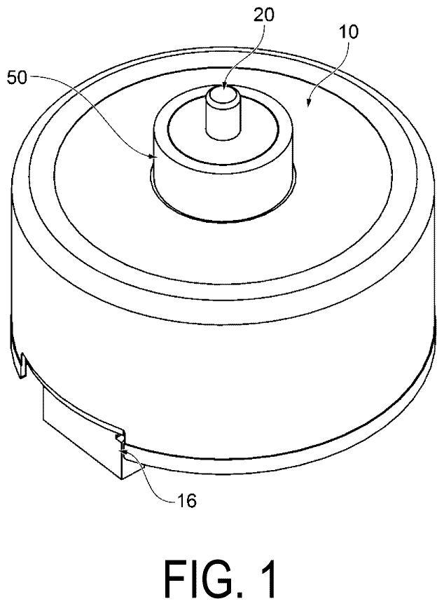

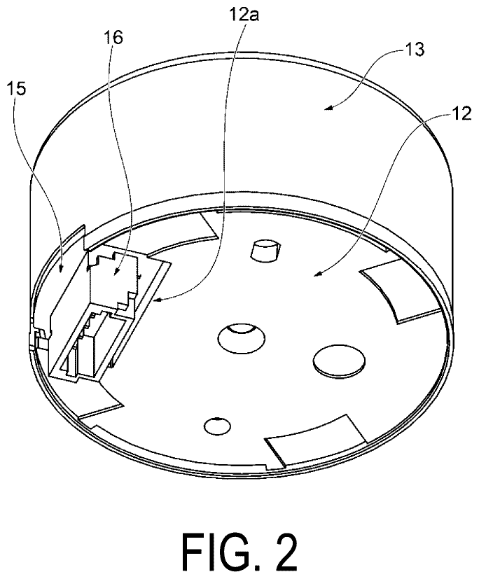

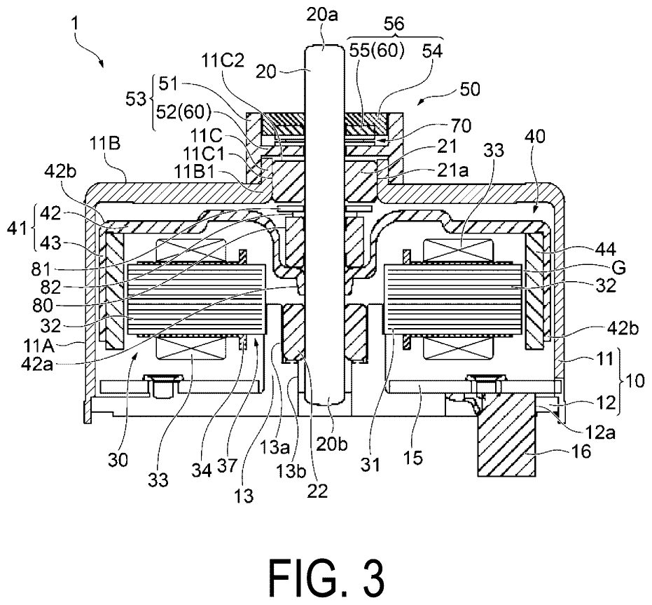

FIG. 1 is a perspective view of a motor 1 according to a first embodiment, as viewed from one side, FIG. 2 is a perspective view of the motor 1 as viewed from the other side, and FIG. 3 is a cross-sectional view of the motor 1 taken along a direction of a shaft. As illustrated in FIGS. 1 to 3, the motor 1 according to the present embodiment includes, as main configurations, a housing 10, a shaft (rod) 20, a bearing 21, a bearing 22, a stator 30, a rotor 40, and a lid 50. The shaft 20 includes one end part 20a and the other end part 20b. That is, FIG. 1 is a view from the one end part 20a side of the shaft 20, and FIG. 2 is a view from the other end part 20b side of the shaft 20.

The housing 10 includes a base 12 forming a bottom part of the housing 10 and a frame 11 forming a side surface and a top surface of the housing 10.

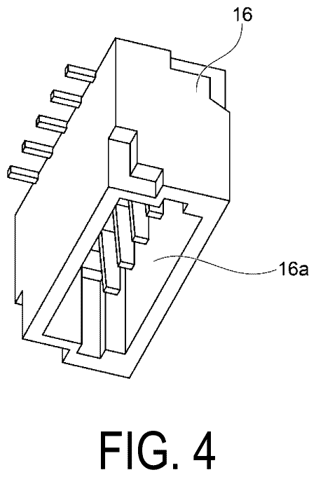

The base 12 is a disk-shaped member forming the bottom part of the housing 10 and is disposed perpendicular to a longitudinal direction of the shaft 20 (i.e., extends in a radial direction). At a center of the base 12, a tubular tube part 13 extending along the longitudinal direction of the shaft 20 (hereinafter, simply referred to as “longitudinal direction”) is formed integrally with the base 12. Further, a hole part is formed with at an inner side of an inner peripheral part of the tube part 13, and the shaft 20 passes through the hole part. A board (hereinafter, referred to as a circuit board) 15 mounted with electronic components such as a capacitor and a resistor element and including a wiring and a terminal is placed at a surface of the base 12 at the one end part 20a side (hereinafter, referred to as an “upper side”) of the shaft 20 in the longitudinal direction of the shaft 20. A recessed part 12a is formed in the radial direction at a part of the base 12, and the base 12 has an opening by the recessed part 12a. A connector 16 to be electrically connected to an external device is disposed at an inner side of the recessed part 12a. As illustrated in FIG. 4, an opening 16a is formed at a lower side of the connector 16, and a terminal of the external device is inserted into the opening 16a and connected to the connector 16. That is, the connector 16 is electrically connected to the circuit board 15 through the recessed part 12a, and the motor 1 is electrically connected to the external device. The connector 16 is located at the base 12 side (hereinafter, referred to as “lower side”) with respect to the circuit board 15. A current is supplied from the outside to a coil 33 (described below) of the stator 30 via the connector 16, the circuit board 15, and a connection terminal provided to the stator 30.

The frame 11 includes a cylindrical first tube part (hereinafter, referred to as a large-diameter tube) 11A, a disk-shaped top surface part (hereinafter, referred to as a disk part) 11B, and a cylindrical second tube part (hereinafter, referred to as a small-diameter tube) 11C having an outer shape smaller than an outer shape of the large-diameter tube 11A. Further, the small-diameter tube 11C may be simply referred to as a tube 11C. The large-diameter tube 11A is fixed to an outer peripheral part of the base 12 and extends upward substantially from a position of the base 12 in the longitudinal direction of the shaft 20. The disk part 11B extends in the radial direction and extends from an upper end of the large-diameter tube 11A toward the shaft 20. Note that, hereinafter, a side from the large-diameter tube 11A toward the shaft 20 is referred to as “inner side” or “inner”, and a side from the shaft 20 toward the large-diameter tube 11A is referred to as “outer side” or “outer”. The tube 11C extends (upward) from an inner peripheral part 11B1 of the disk part 11B toward the one end part 20a of the shaft 20. A through hole 11C2 is formed at an inner side of an inner peripheral surface 11C1 of the tube 11C. Note that in the present embodiment, the large-diameter tube 11A, the disk part 11B, and the tube 11C are integrally formed.

The shaft 20, the bearing 21, the bearing 22, the stator 30, the rotor 40, and the like are accommodated in the housing 10 having such a configuration.

The bearing 21 is disposed at an inner side of the tube 11C, and an outer peripheral surface 21a of the bearing 21 is fixed to the inner peripheral surface 11C1 of the tube 11C. The bearing 22 is disposed at an inner side of an inner peripheral surface 13a of the tube part 13, and an outer peripheral surface of the bearing 22 is fixed to the inner peripheral surface of the tube part 13. Examples of the bearings 21 and 22 include ball bearings, sleeve bearings, and the like. Note that the inner peripheral surface 13a of the tube part 13 is formed with a step part 13b. In the longitudinal direction of the shaft 20, the bearing 22 is supported by the step part 13b. An outer peripheral surface of the shaft 20 is supported by an inner peripheral surface of the bearing 21 and an inner peripheral surface of the bearing 22. Thus, the bearings 21 and 22 rotatably support the shaft 20. In this manner, the bearing 21 rotatably supports the shaft 20 being one of the shaft 20 and the tube 11C and is fixed to the tube 11C being the other of the shaft 20 and the tube 11C. In addition, the bearing 22 rotatably supports the shaft 20 being one of the shaft 20 and the tube part 13 and is fixed to the tube part 13 being the other of the shaft 20 and the tube part 13. One end part 20a (upper end part) of the shaft 20 protrudes upward from the lid 50 to be described below, and the other end part 20b (lower end part) of the shaft 20 is located at an inner side of the tube part 13.

The stator 30 is fixed to the housing 10 directly or via another member and includes a stator core 37 formed of a plurality of magnetic bodies such as electromagnetic steel sheets, an insulator 34 surrounding the stator core 37, and a plurality of coils 33 wound around the insulator 34. The stator core 37 includes a circular annular part (core) 31 concentric with the shaft 20, and a plurality of teeth (magnetic pole parts) 32 formed so as to extend radially outward from the circular annular part 31. At least a part of the circular annular part 31 and the teeth 32 is covered with the insulator 34. The plurality of coils 33 are wound around the insulator 34 covering each of the plurality of teeth 32. Thus, the stator core 37 and the plurality of coils 33 are insulated. As described above, a current is supplied from the outside to the plurality of coils 33 via the connector 16, the circuit board 15, and the connection terminal provided to the stator 30.

The rotor 40 includes a holder 41 and a magnet 44. The holder 41 is formed of a magnetic body and includes a cylindrical tube part 43 and an annular part 42 extending from an end part of the tube part 43 at the disk part 11B side toward the shaft 20. The annular part 42 is formed integrally with the tube part 43. The annular part 42 is annular when viewed from the upper side and includes an inner peripheral part 42a. The shaft 20 passes through the inner peripheral part 42a of the annular part 42 and is fixed to an inner peripheral surface of the inner peripheral part 42a. Therefore, the holder 41 and the shaft 20 rotate integrally. In addition, a spacer 80, a ring 81, and a second ring 82 having an outer shape (or an outer diameter) smaller than an outer shape of the spacer 80 and an outer shape of the ring 81 are disposed between the inner peripheral part 42a of the annular part 42 and the shaft 20 in the radial direction. The tube part 43 extends downward from an outer peripheral part 42b of the annular part 42. In the longitudinal direction of the shaft 20, an end part (lower end part) of the tube part 43 at the base 12 side is located at the base 12 side from the stator core 37. The magnet 44 has an annular shape and is fixed to an inner peripheral surface of the tube part 43. In addition, in the magnet 44, a plurality of different magnetic poles (N pole and S pole) are alternately formed along a circumferential direction. The magnet 44 opposes an outer peripheral surface of the stator core 37 via an air gap G.

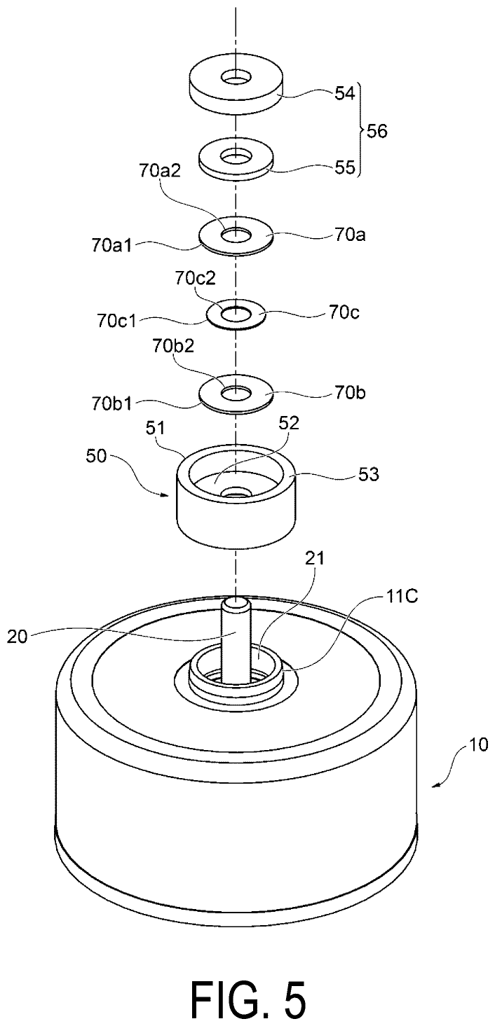

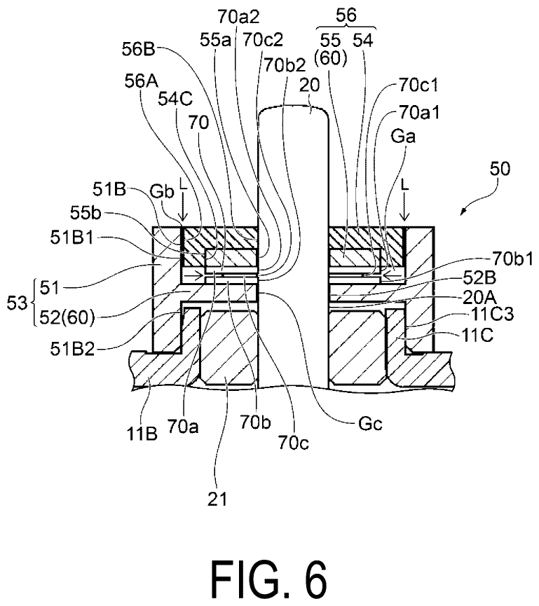

FIG. 5 is a view illustrating the lid 50 in an exploded state, together with the housing 10. FIG. 6 is an enlarged view of a part of the motor 1, and specifically, an enlarged view of the vicinity of the lid 50. As illustrated in FIGS. 5 and 6, the lid 50 covers the bearing 21 and the tube 11C. The lid 50 includes a first member 56 and a second member 53.

The first member 56 is an annular member when viewed from the upper side, and specifically has a circular annular shape. The first member 56 being an annular member includes an inner peripheral part 56B, and a through hole is formed at an inner side of the inner peripheral part 56B. The shaft 20 passes through the through hole of the first member 56, and the outer peripheral surface 20A of the shaft 20 is fixed to the inner peripheral part 56B of the first member 56. A member different from the member forming the first member 56 is fixed to the first member 56. Specifically, the first member 56 includes a main body part 54 formed of a non-magnetic body such as brass. A magnet 55 being a magnetic body is fixed to the main body part 54. Furthermore, a recessed part 54C is formed at a surface of the main body part 54 at the bearing 21 side, and the magnet 55 is accommodated and fixed in the recessed part 54C. The first member 56 extends in the radial direction from the shaft 20 and has a substantially rectangular shape. In addition, the first member 56 forms a wall with respect to the bearing 21. Hereinafter, the first member 56 is referred to as a first wall 56. The first wall 56 has the magnet 55.

The second member 53 is a tubular member and is cylindrical in the present embodiment. The second member 53 being a tubular member includes a sleeve 51 and a second wall 52. At least the second wall 52 of the second member 53 is formed of a magnetic body such as iron. That is, the second wall 52 has a magnetic body. In the present embodiment, the sleeve 51 and the second wall 52 are integrally formed.

The sleeve 51 extends from a surface of the disk part 11B of the frame 11 to the one end part 20a side (upper side) of the shaft 20, and a surface of the sleeve 51 at the one end part 20a side of the shaft 20 is substantially flush with a surface of the first wall 56 at the one end part 20a side of the shaft 20. An inner peripheral surface 51B2 of a portion of the sleeve 51 at the bearing 21 side is fixed to an outer peripheral surface 11C3 of the tube 11C. On the other hand, an inner peripheral surface 51B1 of an upper portion of the sleeve 51 opposes an outer peripheral part 56A of the first wall 56 in the radial direction. Further, a gap is present between the outer peripheral part 56A of the first wall 56 and an inner peripheral surface 51B of the sleeve 51 in the radial direction. Thus, the first wall 56 can rotate together with the shaft 20 with respect to the second member 53.

The second wall 52 is located in the vicinity of a center (intermediate part) of the sleeve 51 in the longitudinal direction and extends (inward) in a direction from the tube 11C toward the shaft 20 in the radial direction. In the longitudinal direction of the shaft 20, the second wall 52 opposes the first wall 56 via another member. In the longitudinal direction of the shaft 20, a gap Ga is present between the second wall 52 and the first wall 56. The second wall 52 has a ring-like planar shape. The second wall 52 includes an inner peripheral part 52B, and a through hole is formed at an inner side of the inner peripheral part 52B. The shaft 20 passes through the through hole of the second wall 52. The inner peripheral part 52B of the second wall 52 opposes the outer peripheral surface 20A of the shaft 20. In addition, in the radial direction, a gap Gc is present between the inner peripheral part 52B of the second wall 52 and the outer peripheral surface 20A of the shaft 20. Thus, the shaft 20 can rotate with respect to the second member 53.

In this way, the first wall 56, the second member 53, and the shaft 20 form a labyrinth formed by the gap Gb between the outer peripheral part 56A of the first wall 56 and the sleeve 51, the gap Ga, and the gap Gc between the inner peripheral part 52B of the second wall 52 and the outer peripheral surface 20A of the shaft 20. That is, the first wall 56 and the second wall 52 form a labyrinth.

A washer (ring) 70 as another member different from the first wall 56 and the second wall 52 is disposed in the gap Ga between the first wall 56 and the second wall 52. That is, in the longitudinal direction, the washer 70 is sandwiched between the first wall 56 and the second wall 52, and the first wall 56 and the second wall 52 oppose each other via the washer 70 being another member. The washer 70 has a ring-like planar shape, and the shaft 20 passes through a through hole at an inner side of an inner peripheral part of the washer 70.

In the present embodiment, there are a plurality of (for example, three) washers overlapping each other in the longitudinal direction of the shaft 20. The plurality of washers 70 are formed of a metal plate or a resin plate. Front and back surfaces of the plurality of washers 70 are smooth surfaces. Among the plurality of washers 70, sizes (outer diameters) of outer peripheral parts 70a1 and 70b1 and sizes (inner diameters) of inner peripheral parts 70a2 and 70b2 of a washer 70a at the first wall 56 side and a washer 70b at the second wall 52 side are substantially the same as a size (inner diameter) of an inner peripheral part 55a and a size (outer diameter) of an outer peripheral part 55b of the magnet 55. On the other hand, a size (inside diameter) of an inner peripheral part 70c2 of a washer 70c between the washer 70a and the washer 70b is substantially the same as sizes (inside diameters) of inner peripheral parts 70a2 and 70b2 of the washer 70a and the washer 70b, and a size (outer diameter) of an outer peripheral part 70c1 of the washer 70c is smaller than the sizes (outer diameters) of the outer peripheral parts 70a1 and 70b1 of the washer 70a and the washer 70b. With such a configuration, one of the plurality of washers 70 substantially entirely covers the surface of the magnet 55 at the bearing 21 side.

The plurality of washers 70a, 70b, and 70c may be rotatable with respect to the shaft 20. In this case, the plurality of washers 70a, 70b, and 70c serve as sliding members, and among surfaces of the plurality of washers 70a, 70b, and 70c, surfaces (front surfaces or back surfaces) opposing each other serve as sliding surfaces. In addition, the washers 70a and 70b may be slidable with respect to the first wall 56 and the second wall 52. In this case, surfaces of the plurality of washers 70a and 70b opposing the first wall 56 and the second wall 52 serve as sliding surfaces. With such a configuration, the shaft 20 can rotate while reducing a load associated with sliding.

Here, the magnet 55 opposes the second wall 52 having a magnetic body via the washers 70. In addition, the magnet 55 has two different magnetic poles in the longitudinal direction of the shaft 20. For example, the magnet 55 has an N pole at the one end part 20a side of the shaft 20 and an S pole at the other end part 20b side of the shaft 20. Thus, in the longitudinal direction of the shaft 20, the first wall 56 including the magnet 55 is urged toward the second wall 52 by the magnetic force of the magnet 55. That is, the magnet 55 and the second wall 52 constitute an urging structure 60 urging the first wall 56 toward the second wall 52 in the longitudinal direction. As a result of the first wall 56 being urged toward the second wall 52 by the urging structure 60, in the longitudinal direction, a gap between the washer 70 and the first wall 56 is substantially closed and a gap between the washer 70 and the second wall 52 is substantially closed.

When a current is supplied to the coil 33 of the motor 1 having such a configuration, a magnetic interaction occurs between the coil 33 and the magnet 44, and a force for rotating the rotor 40 with respect to the stator 30 and the housing 10 is generated. Here, the rotor 40 is fixed to the shaft 20. In addition, the shaft 20 is rotatably supported by the bearings 21 and 22. Thus, the force causing the rotor 40 to rotate with respect to the stator 30 and the housing 10 also causes the shaft 20 to rotate with respect to the stator 30 and the housing 10. That is, when a current is supplied to the plurality of coils 33 from the external device, the rotor 40 and the shaft 20 integrally rotate. As such, the motor 1 according to the present embodiment is configured as a brushless motor at an outer rotor side.

As described above, the gap Gb is present between the outer peripheral part 56A of the first wall 56 and the inner peripheral surface 51B of the sleeve 51. Therefore, as illustrated in FIG. 6, a liquid L such as water may infiltrate through the gap Gb. The liquid L infiltrating through the gap between the outer peripheral part 56A of the first wall 56 and the inner peripheral surface 51B of the sleeve 51 attempts to infiltrate inward along the radial direction through the gap Ga between the second wall 52 and the first wall 56 forming the labyrinth. However, as described above, the plurality of washers 70 are disposed in the gap Ga. The first wall 56 is urged toward the second wall 52 by the magnetic force of the urging structure 60. As a result, in the longitudinal direction of the shaft 20, the gap between the plurality of washers 70 and the first wall 56 is substantially closed, and the gap between the plurality of washers 70 and the second wall 52 is substantially closed. Thus, the urging structure 60 suppresses the liquid L infiltrating through the gap Ga from further infiltrating inward toward the shaft 20. Therefore, the motor 1 with high waterproof performance can be provided.

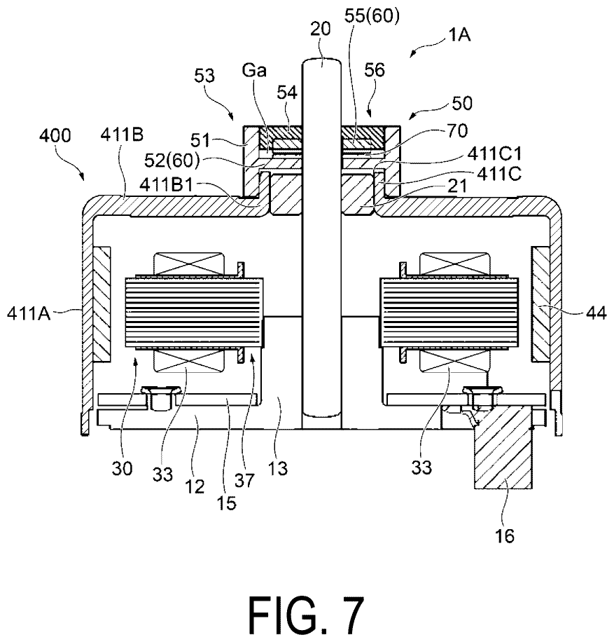

Next, a motor 1A according to a modification of the first embodiment will be described with reference to FIG. 7. Note that the same configurations as the configurations in the first embodiment will be given the same reference signs, and descriptions of the configurations will be omitted.

As illustrated in FIG. 7, the motor 1A has substantially the same configuration as the motor 1. However, the motor 1A does not have a housing such as the housing 10 whereas the motor 1 has the housing 10, and the motor 1A differs from the motor 1 in the point.

In the motor 1A, the stator 30 is fixed to the base 12. In a rotor 400 of the motor 1A, the shaft 20, the bearings 21 and 22, the stator 30, and the like are accommodated inside the rotor 400. The rotor 400 includes a cylindrical first tube part (hereinafter, referred to as a large-diameter tube) 411A, a disk-shaped top surface part (hereinafter, referred to as a disk part) 411B, and a cylindrical second tube part (hereinafter, referred to as a small-diameter tube) 411C having an outer diameter smaller than the large-diameter tube 411A. Further, the small-diameter tube 411C may be simply referred to as a tube 411C. The outer peripheral part of the base 12 is located at an inner side of the large-diameter tube 411A and extends substantially from the position of the base 12 toward the one end part 20a side (upper side) of the shaft 20 in the longitudinal direction of the shaft 20. The disk part 411B extends in the radial direction and extends from an upper end of the large-diameter tube 411A toward the shaft 20. The tube 411C extends from an inner peripheral part 411B1 of the disk part 411B toward the one end part 20a side (upper side) of the shaft 20. That is, a through hole surrounded by an inner peripheral surface 411C1 of the tube 411C is present at a center of the disk part 411B. The large-diameter tube 411A, the disk part 411B, and the tube 411C are integrally formed. The sleeve 51 of the lid 50 is fixed to the tube 411C. Unlike the motor 1, in the motor 1A, the other end part 20b of the shaft 20 is fixed to the tube part 13. In addition, unlike the motor 1, in the motor 1A, the bearing 21 rotatably supports the tube 411C being one of the shaft 20 and the tube 411C and is fixed to the shaft 20 being the other of the shaft 20 and the tube 411C. With such a configuration, in this modification, the rotor 400 and the first member 56 rotate with respect to the stator 30, the base 12, and the shaft 20.

According to such a motor 1A, as a result of the first wall 56 being urged toward the second wall 52 by the magnetic force of the urging structure 60, in the longitudinal direction of the shaft 20, the gap between the plurality of washers 70 and the first wall 56 is substantially closed and the gap between the plurality of washers 70 and the second wall 52 is substantially closed. Thus, the washers 70 suppress the liquid L infiltrating through the gap Ga from further infiltrating toward the shaft 20 (see FIG. 6). Therefore, the motor 1A with high waterproof performance can be provided.

Note that, in the description of the example in the motor 1 according to the first embodiment and the motor 1A according to the modification of the first embodiment, the first wall 56 being one of the first wall 56 and the second wall 52 has the magnet 55, and the second wall 52 being the other of the first wall 56 and the second wall 52 has the magnetic body. However, the first wall 56 may have a magnetic body and the second wall 52 may have a magnet.

In addition, in the description of the example in the motor 1 according to the first embodiment and the motor 1A according to the modification of the first embodiment, the size (outer diameter) of the outer shape of the plurality of washers 70 being other members is substantially the same as the size (outer diameter) of the outer shape of the magnet 55. However, the size (outer diameter) of the outer shape of the other members may be smaller or larger than the size (outer diameter) of the outer shape of the magnet 55. In addition, a material forming the other members may be a non-magnetic body such as brass or aluminum, or a resin member such as polyethylene, and is not particularly limited as long as the first wall 56 is urged toward the second wall 52.

### Second Embodiment

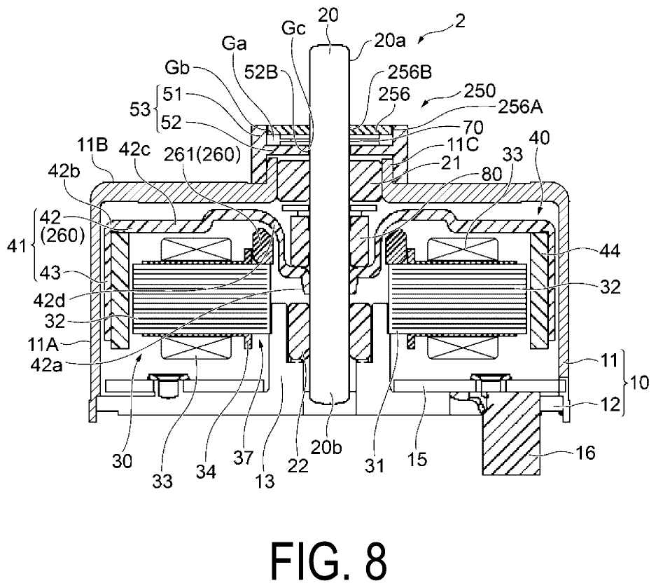

Next, a motor according to a second embodiment will be described. FIG. 8 is a cross-sectional view illustrating a motor 2 according to the second embodiment, taken along the longitudinal direction. As illustrated in FIG. 8, a configuration of an urging structure of the motor 2 is different from the configuration of the urging structure 60 of the motor 1 according to the first embodiment, and the motor 2 has substantially the same configuration as the motor 1 according to the first embodiment except for the point. Therefore, regarding the motor 2, only points related to the urging structure will be described below, and the other configurations will be denoted by the same reference numerals as the reference numerals of the first embodiment, and descriptions of the other configurations will be omitted.

As illustrated in FIG. 8, the motor 2 includes a lid 250. The lid 250 covers the bearing 21 and the tube 11C. The lid 250 includes a first member 256 and a second member 53. The first member 256 is a plate-like member extending in the radial direction from the shaft 20 and having a ring-like (circular and annular) planar shape and is formed of metal in the present embodiment. The first member 256 extends in the radial direction from the shaft 20 and has a rectangular cross-sectional shape. In addition, the first member 56 forms a wall with respect to the bearing 21. Hereinafter, the first member 256 is referred to as a first wall 256. That is, the lid 250 includes the first wall 256 and the second wall 52.

An inner peripheral part 256B of the first wall 256 is fixed to the outer peripheral surface 20A (see FIG. 6) of the shaft 20. On the other hand, an outer peripheral part 256A of the first wall 256 opposes the inner peripheral surface 51B (see FIG. 6) of the sleeve 51 via the gap Gb in the radial direction. Thus, the first wall 256 can rotate with respect to the second member 53. In addition, a gap Ga is formed between the first wall 256 and the second wall 52 in the longitudinal direction of the shaft 20, and the plurality of washers 70 are disposed in the gap Ga. That is, the washers 70 are sandwiched between the first wall 256 and the second wall 52. In addition, as described in the first embodiment, the gap Gc is present between the inner peripheral part 52B of the second wall 52 and the outer peripheral surface of the shaft 20 in the radial direction. Therefore, the first wall 256, the second member 53, and the shaft 20 form a labyrinth formed by the gap Gb between the outer peripheral part of the first wall 256 and the sleeve 51, the gap Ga, and the gap Gc between the inner peripheral part of the second wall 52 and the outer peripheral surface of the shaft 20. That is, the first wall 256 and the second wall 52 form a labyrinth.

The stator core 37 constituting the stator 30 of the motor 2 is provided with a ring-shaped magnet 261. More specifically, the magnet 261 is located at the shaft 20 side with respect to the insulator 34 in the radial direction. In addition, the magnet 261 opposes a surface of the annular part 42 of the holder 41 at the stator 30 side in the longitudinal direction of the shaft 20. Further, the magnet 261 has different two magnetic poles in the longitudinal direction of the shaft 20, and for example, has an N pole at the one end part 20a side of the shaft 20 and an S pole at the other end part 20b side of the shaft 20. The annular part 42 (magnetic body) of the holder 41 constituting the rotor 40 includes an inner peripheral part 42a fixed to the shaft 20, an outer peripheral part 42b connecting to the tube part 43, a part 42c extending in the radial direction from the outer peripheral part 42b toward the inner peripheral part 42a, and a bent part 42d bent in the vicinity of the spacer 80. The radially extending part 42c extends to the shaft 20 through a space between the magnet 261 and the disk part 11B of the housing 10 in the longitudinal direction of the shaft 20. In the longitudinal direction or the radial direction of the shaft 20, the magnet 261 opposes the bent part 42d, and a magnetic force as an urging force acts between the bent part 42d of the annular part 42 and the magnet 261.

According to the motor 2, the rotor 40 is urged toward the magnet 261 side (lower side) by the magnetic force acting on the annular part 42 (magnetic body of the rotor 40) and the magnet 261 provided to the stator 30. The rotor 40 (annular part 42) is fixed to the shaft 20, and the first wall 256 is also fixed to the shaft 20. Thus, as the rotor 40 is urged downward, the first wall 256 is also urged downward. That is, in the longitudinal direction of the shaft 20, the first wall 256 is urged toward the second wall 52. As such, in the motor 2, the annular part 42 (magnetic body) of the rotor 40 and the magnet 261 provided to the stator 30 constitute an urging structure 260, and the first wall 256 is urged toward the second wall 52 by the urging structure 260.

In the motor 2, since the first wall 256 is urged toward the second wall 52, in the longitudinal direction of the shaft 20, the gap between the plurality of washers 70 and the first wall 256 is substantially closed and the gap between the plurality of washers 70 and the second wall 52 is substantially closed. Thus, the washers 70 suppress a liquid infiltrating through the gap Ga from further infiltrating in the radial direction toward the shaft 20 (see FIG. 6). Therefore, the motor 2 with high waterproof performance can be provided.

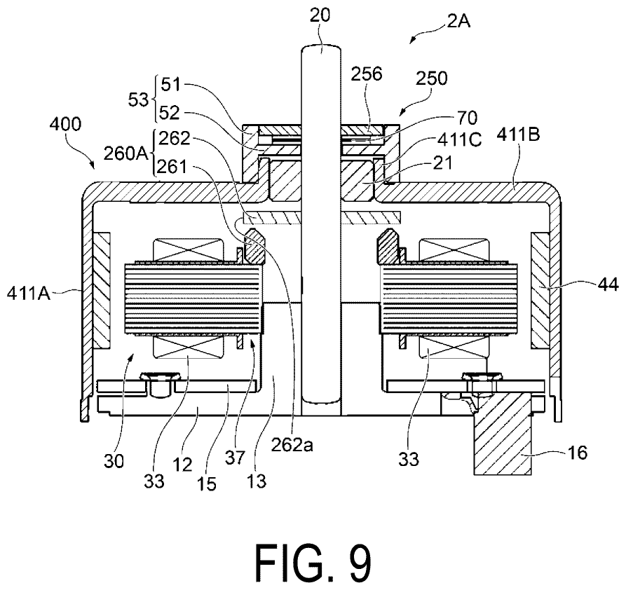

Next, a motor 2A according to a modification of the second embodiment will be described with reference to FIG. 9. As illustrated in FIG. 9, the motor 2A includes a rotor 400 having a similar configuration to the configuration of the motor 1A according to the modification of the first embodiment (that is, the motor 2A does not have a housing such as the housing 10), a configuration of the urging structure of the motor 2A is different from the configuration of the urging structure 260 of the motor 2 according to the second embodiment, and the motor 2A has the same configuration as the motor 2 according to the second embodiment except for the points. Therefore, regarding the motor 2A, only points related to the urging structure will be described below, and the other configurations will be denoted by the same reference numerals as the reference numerals of the first embodiment, the modification of the first embodiment, and the second embodiment, and descriptions thereof will be omitted.

As illustrated in FIG. 9, the motor 2A includes a ring-shaped plate-like member 262 formed of a magnetic body (e.g., iron). The plate-like member 262 is disposed at an inner side of the rotor 400. In addition, the plate-like member 262 is fixed to the outer peripheral surface of the shaft 20 and is located between the magnet 261 and the disk part 411B of the rotor 400 in the longitudinal direction of the shaft 20. In addition, an outer peripheral part 262a of the plate-like member 262 and the magnet 261 oppose each other in the longitudinal direction of the shaft 20. A magnetic force as an urging force acts between the plate-like member 262 and the magnet 261.

According to the motor 2A, the plate-like member 262 is urged toward the magnet 261 side (lower side) by the magnetic force acting on the plate-like member 262 being a magnetic body and the magnet 261 provided to the stator 30. The plate-like member 262 is fixed to the shaft 20, and the first wall 256 is also fixed to the shaft 20. Thus, as the plate-like member 262 is urged downward, the shaft 20 and the first wall 256 are also urged downward. That is, in the longitudinal direction of the shaft 20, the first wall 256 is urged toward the second wall 52. As such, in the motor 2A, the plate-like member 262 and the magnet 261 constitute an urging structure 260A, and the first wall 256 is urged toward the second wall 52 by the urging structure 260A.

In the motor 2A, since the first wall 256 is urged toward the second wall 52, in the longitudinal direction of the shaft 20, the gap between the washers 70 and the first wall 256 is substantially closed and the gap between the washers 70 and the second wall 52 is substantially closed. Thus, the washers 70 suppress a liquid infiltrating through the gap Ga from further infiltrating in the radial direction toward the shaft 20 (see FIG. 6). Therefore, the motor 2A with high waterproof performance can be provided.

The present invention has been described with reference to the embodiments, but the present invention is not limited to the embodiments.

For example, in the description of the example in the above described first embodiment, second embodiment, and modifications of the first embodiment and the second embodiment, the first wall 56, 256 and the second wall 52 oppose each other via another member. However, the first wall 56, 256 and the second wall 52 may directly oppose each other without another member as long as the rotor 40, 400 rotates with respect to the stator 30 and the like.

In addition, the motor according to the present invention can be appropriately modified to other motors such as a brushless motor and a fan motor by one skilled in the art according to knowledge known in the related art. Such modifications are, of course, included in the scope of the present invention as long as these modifications still include the configuration of the disclosure.

### REFERENCE SIGNS LIST

1, 1A, 2, 2A: motor, 10: housing, 11C, 411C: tube, 20A: outer peripheral surface, 21: bearing, 30: stator, 40, 400: rotor, 50, 250: lid, 51: sleeve, 52: second wall, 52B, 252B: inner peripheral part, 55, 261: magnet, 56, 256: first wall, 56A, 256A: outer peripheral part, 56B, 256B: inner peripheral part, 60, 260, 260A: urging structure, Ga, Gb, Gc: gap

1. A motor comprising:
a rod including one end part and the other end part;
a tube;
a bearing rotatably supporting one of the rod and the tube and fixed to the other;
a lid covering the bearing and the tube; and
an urging structure, wherein
the lid includes a first wall fixed to the rod and a second wall fixed to the tube,
the first wall and the second wall oppose each other directly or via another member in a longitudinal direction of the rod, and
the urging structure urges the first wall toward the second wall in the longitudinal direction of the rod.

2. The motor according to claim 1, wherein
the first wall extends in a radial direction from the rod, and
the second wall extends, in the radial direction, in a direction from the tube toward the rod.

3. The motor according to claim 1, wherein
the urging structure includes a magnet, and
the first wall is urged toward the second wall by a magnetic force.

4. The motor according to claim 3, wherein
one of the first wall and the second wall includes a magnetic body, and
the other of the first wall and the second wall includes the magnet.

5. The motor according to claim 1, comprising the other member sandwiched between the first wall and the second wall.

6. The motor according to claim 1, wherein
the lid includes an annular member fixed to the rod, and a tubular member fixed to the tube,
the annular member includes the first wall,
the first wall includes a magnet,
the tubular member includes a sleeve fixed to the tube, and the second wall extending from the sleeve toward the rod, and
the second wall includes a magnetic body.

7. The motor according to claim 6, wherein
a gap is present between an outer peripheral part of the first wall and the sleeve in the radial direction,
a gap is present between an inner peripheral part of the second wall and an outer peripheral surface of the rod in the radial direction, and
the first wall and the second wall form a labyrinth.

8. The motor according to claim 1, comprising a rotor fixed to the rod, and a stator, wherein
the urging structure includes a magnetic body of the rotor, and a magnet provided at the stator,
the lid includes an annular member fixed to the rod, and a tubular member fixed to the tube,
the annular member includes the first wall,
the tubular member includes a sleeve fixed to the tube, and the second wall extending from the sleeve toward the rod, and
the first wall is urged toward the second wall by a magnetic force acting on the magnetic body of the rotor and the magnet provided at the stator.

9. The motor of claim 8, wherein
a gap is present between an outer peripheral part of the first wall and the sleeve in the radial direction,
a gap is present between an inner peripheral part of the second wall and an outer peripheral surface of the rod in the radial direction, and
the first wall and the second wall form a labyrinth.

10. The motor according to claim 1, comprising:
a housing including the tube;
a rotor fixed to the rod; and
a stator fixed to the housing directly or via another member, wherein
the bearing rotatably supports the rod and is fixed to the tube.
